(19) United States
(12) Patent Application Publication
(10) Pub. No.: US 2011/0011270 A1
(43) Pub. Date: Jan. 20, 2011

(54) DISPOSABLE TEA SET AND TEAPOT THEREOF

(76) Inventors: Meng-Hsuan Shih, TAIPEI CITY (TW); Chi-Han Wang, TAIPEI CITY (TW); Yu-Chi Chen, TAIPEI CITY (TW); Chi-Chen Lin, TAIPEI CITY (TW); Chia-En Lu, TAIPEI CITY (TW)

Correspondence Address: NORTH AMERICA INTELLECTUAL PROPERTY CORPORATION, P.O. BOX 506, MERRIFIELD, VA, 22116, US

(21) Appl. No.: 12/837,446

(22) Filed: Jul. 15, 2010

(30) Foreign Application Priority Data
Jul. 17, 2009 (TW) 098213092

(51) Int. Cl. A47J 31/44

(52) U.S. Cl. 99/279

(57) ABSTRACT

A disposable tea set includes a teapot and a teacup. The teapot is folded from a first sheet, and the first sheet includes a pot bottom portion, a plurality of pot wall portions, a plurality of folding portions, and a pot lid portion. The pot wall portions surround and are connected with the pot bottom portion, and the pot wall portions and the pot bottom portion form seamless connections. The folding portions are connected with the pot wall portions which are adjacent to each other, respectively, and they are folded to make the pot wall portions to form a pot body. One of the folding portions extends to outside of the pot body to form a spout. The pot lid portion is connected with one of the pot wall portions. The teacup is folded from a second sheet and is accommodated in the teapot.

### CROSS-REFERENCE TO RELATED APPLICATIONS

This Non-provisional application claims priority under 35 U.S.C. §119(a) on Patent Application No(s). 098213092 filed in Taiwan, Republic of China on Jul. 17, 2009, the entire contents of which are hereby incorporated by reference.

### BACKGROUND OF THE INVENTION

1. Field of the Invention

This invention relates to a tea set and a teapot thereof and, more particularly, to a disposable tea set and a teapot thereof.

2. Description of the Related Art

Tea is one of the most widely-consumed beverages in eastern countries. In a conventional method for infusing tea, mostly a ceramic teapot and a ceramic teacup are used. First, tea leaves are placed into the teapot, and then hot water is poured into the teapot to allow the toasted tea leaves to expand, such that sweet flavor and fragrance of the tea leaves are diffused and the tea flavor is retained in the teapot via a pot lid to allow the tea to be more perfumed.

However, the ceramic teapot and teacup are heavy and fragile, and they cannot be conveniently taken. Therefore, people usually fail to use a teapot to infuse tea at any time and any place to enjoy drinking tea. In addition, for example, in an office, people usually use a teacup to infuse a tea bag, which is convenient. However, since the teacup is an open vessel, the flavor of the tea may be easily diffused, and mostly the portions such as tea stems with poor flavor are used in a general tea bag. To sum up, via the present tea set, users are difficult to enjoy infusing tea and to obtain better tea diffused with flavor all around at the same time.

### BRIEF SUMMARY OF THE INVENTION

One objective of this invention is to provide a disposable tea set and a teapot thereof capable of allowing a user to enjoy infusing tea.

In the invention, a teapot is folded from a sheet. The sheet includes a pot bottom portion, a plurality of pot wall portions, a plurality of folding portions, and a pot lid portion. The pot wall portions surround and are connected with the pot bottom portion, and the pot wall portions and the pot bottom portion are seamless. The folding portions are connected with the pot wall portions which are adjacent to each other respectively, and they are folded to make the pot wall portions to form a pot body. One of the folding portions extends to outside of the pot body to form a spout. The pot lid portion is connected with one of the pot wall portions.

In the invention, a disposable tea set includes a teapot and a teacup. The teapot is folded from a first sheet. The first sheet includes a pot bottom portion, a plurality of pot wall portions, a plurality of folding portions, and a pot lid portion. The pot wall portions surround and are connected with the pot bottom portion, and the pot wall portions and the pot bottom portion are seamless. The folding portions are connected with the pot wall portions which are adjacent to each other respectively, and they are folded to make the pot wall portions to form a pot body. One of the folding portions extends to outside of the pot body to form a spout. The pot lid portion is connected with one of the pot wall portions. The teacup is folded from a second sheet and is accommodated in the teapot.

In one embodiment of the invention, the teapot may have a first folding line for storage, and the teapot may be foldable along the first folding line.

In one embodiment of the invention, the folding portions and the pot wall portions of the teapot may are seamless.

In one embodiment of the invention, one of the folding portions may extend to be attached to one of the pot wall portions to strengthen the pot body.

In one embodiment of the invention, one of the folding portions of the teapot may extend to outside of the pot body to form a handle.

According to above, in the invention, the teapot and the teacup included by the disposable tea set are folded from a single sheet, such as paper, respectively. Thereby, the teapot and the teacup are light, and the teacup can be accommodated in the teapot. Further, the teapot and the teacup are foldable, such that the disposable tea set in the invention can be conveniently taken and used. In addition, the teapot in the invention has a pot lid portion. Thereby, when users infuse a tea bag, the tea flavor may be retained in the teapot to allow the tea to be more perfumed. Therefore, the users may enjoy infusing tea and obtain better tea at the same time.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a disposable tea set according to one preferred embodiment of the invention;

FIG. 2 is a schematic diagram showing a first sheet of a teapot in an unfolded state according to one preferred embodiment of the invention;

FIG. 3 is a schematic diagram showing a teacup of a disposable tea set in an unfolded state according to one preferred embodiment of the invention;

FIG. 4 is a schematic diagram showing a storage mode of a disposable tea set according to one preferred embodiment of the invention; and

FIG. 5 is a schematic diagram showing a disposable tea set in a storage state according to one preferred embodiment of the invention.

### DETAILED DESCRIPTION OF THE INVENTION

A disposable tea set and a teapot thereof according to one preferred embodiment of this invention are described.

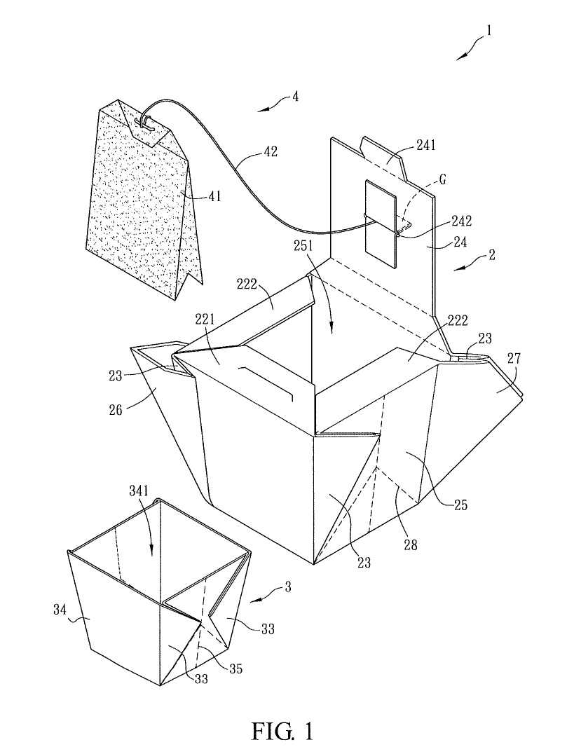

FIG. 1 is a schematic diagram showing a disposable tea set 1 according to one preferred embodiment of the invention. The disposable tea set 1 includes a teapot 2 and a teacup 3.

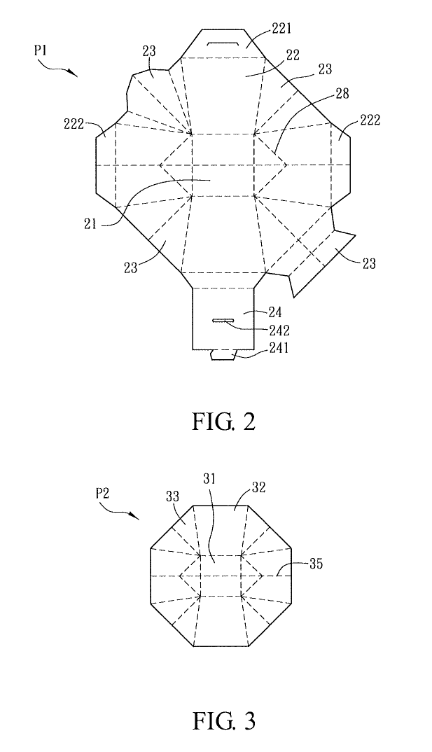

FIG. 2 is a schematic diagram showing a first sheet P1 of the teapot 2 in an unfolded state according to one preferred embodiment of the invention. In FIG. 2, first folding lines of the first sheet P1 are marked by broken lines.

In FIG. 1 and FIG. 2, the teapot 2 is folded from the first sheet P1. The teapot 2 is folded from the single first sheet P1 along the first folding lines in FIG. 2. The first sheet P1 may be made of paper and includes a pot bottom portion 21, a plurality of pot wall portions 22, a plurality of folding portions 23, and a pot lid portion 24.

The pot bottom portion 21 may be circular, square, rectangular, trapezoid, or polygonal. In the embodiment, the pot bottom portion 21 is square. However, the invention is not limited thereto.

The pot wall portions 22 surround and are connected with the pot bottom portion 21, and the pot wall portions 22 and the pot bottom portion 21 are seamless. In other words, the pot wall portions 22 and the pot bottom portion 21 are integrally formed. In addition, the pot wall portions 22 may be square, rectangular, trapezoid, or polygonal. In the embodiment, the pot wall portions 22 are trapezoid. However, the invention is not limited thereto.

The folding portions 23 are connected with the pot wall portions 22 which are adjacent to each other respectively, and they are folded to make the pot wall portions 22 to form a pot body 25. One of the folding portions 23 extends to outside of the pot body 25 to form a spout 26. In addition, the folding portions 23 and the pot wall portions 22 may be seamless. The pot body 25 may be a square cube, a rectangular cube, a trapezoid cube, a cylinder, a polyhedron, or have other foldable shapes. In the embodiment, the pot body 25 is a trapezoid cube. However, the invention is not limited thereto. Further, the pot body 25 has a containing space 251.

In addition, in the embodiment, one of the folding portions 23 extend to be attached to one of the pot wall portions 22 to strengthen the pot body 25. In the embodiment, two folding portions 23 extend to be attached to two pot wall portions 22. The folding portions 23 are attached to the pot wall portions 22 at two opposite sides, respectively. In FIG. 1, the folding portion 23 at one side for strengthening the pot body 25 is shown. However, the folding portion 23 may be also disposed at the opposite side. Thereby, the structural strength of the pot body 25 of the teapot 2 will be improved.

The folding portions 23 for strengthening the pot body 25 are triangular, trapezoid, or have other shapes after folded. Further, the folding portions 23 may be folded into the containing space 251 of the pot body 25 and be fastened to inner surfaces of the pot wall portions 22, or the folding portions 23 may also be folded to outside of the containing space 251 of the pot body 25 and be fastened to outer surfaces of the pot wall portions 22. In the embodiment, the folding portions 23 are triangular, and the folding portions 23 are folded to the outside and are fastened to the outer surfaces of the pot wall portions 22. However, the invention is not limited thereto.

The spout 26 may be a triangular cone, a pentagonal cone, or have other foldable shapes. In the embodiment, the pot spout 26 is a triangular cone. However, the invention is not limited thereto. In addition, in the embodiment, part of the folding portions 23 extending to outside of the pot body to form the spout is attached to one of the pot wall portions 22 to strengthen the spout 26. In the embodiment, two folding portions 23 extend to be attached to two pot wall portions 22. After the folding portions 23 for strengthening the spout 26 are folded, the folding portions 23 may be triangular, trapezoid, or have other shapes. Further, the folding portions 23 may be folded into the containing space 251 of the pot body 25 and be fastened to the inner surfaces of the pot wall portions 22, or the folding portions 23 may also be folded to outside of the containing space 251 of the pot body 25 and be fastened to the outer surfaces of the pot wall portions 22. In the embodiment, the folding portions 23 are triangular, and they are folded to the outside and are located at two sides of the spout 26. Further, the folding portions 23 are fastened to the outer surfaces of the pot wall portions 22. However, the invention is not limited thereto.

In addition, one of the folding portions 23 may extend to outside of the pot body 25 to form a handle 27. The handle 27 is located at the other side of the pot body 25 relative to the spout 26. In other words, the spout 26 and the handle 27 are located at two sides of the pot body 25 along a diagonal line, such that a user can hold the handle 27 to pour tea from the spout 26.

In addition, the folding portion 23 at the handle 27 further extends to strengthen the handle 27. The folding portion 23 for strengthening the handle 27 may be triangular, trapezoid, or have other shapes, and it may be folded to the inside or outside. In the embodiment, the folding portion 23 for strengthening the handle 27 is trapezoid, and it is folded to the inside to be fastened. However, the invention is not limited thereto.

The pot lid portion 24 is connected with one of the pot wall portions 22, and the shape of the pot lid portion 24 may correspond to that of an opening of the containing space 251 of the pot body 25. In the embodiment, the pot lid portion 24 is rectangular. However, the invention is not limited thereto. Certainly, the pot lid portion 24 may also be circular, square, trapezoid, or polygonal. In addition, the pot lid portion 24 may have a connecting element 241, and the connecting element 241 may pass through a slot of a fastening element 221 of the pot wall portion 22 to be fastened. Thereby, the pot lid portion 24 is fastened to and covers the opening of the containing space 251. Further, the pot wall portions 22 have a plurality of extending elements 222. When the pot lid portion 24 covers the opening of the containing space 251, the opening of the containing space 251 is completely covered by the extending elements 222.

In addition, the pot lid portion 24 has a lid handle G. The lid handle G may be formed by a sheet of paper or be directly formed by the first sheet P1 of the teapot 2 at the pot lid portion 24. In the embodiment, a sheet of paper forms the lid handle G, and the sheet of the paper passes through a hole 242 of the pot lid portion 24 to be fastened to the pot lid portion 24 after folded. Thus, the user may easily open or close the pot lid portion 24 by the lid handle G.

FIG. 3 is a schematic diagram showing a teacup 3 of the disposable tea set 1 in an unfolded state according to one preferred embodiment of the invention. In FIG. 3, second folding lines of a second sheet P2 are marked by broken lines.

In FIG. 1 and FIG. 3, the teacup 3 is folded from a second sheet P2. The teacup 3 is folded from the single second sheet P2 along the second folding lines in FIG. 3. The second sheet P2 may be made of paper. In addition, the teacup 3 may include a cup bottom portion 31, a plurality of cup wall portions32, and a plurality of folding portions 33.

The cup wall portions 32 surround and are connected with the cup bottom portion 31, and the cup wall portions 32 and the cup bottom portion 31 are seamless. The folding portions 33 are connected with the cup wall portions 32, respectively, and they are folded to make the cup wall portions 32 to form a cup body 34. In addition, the folding portions 33 may extend to be attached to one of the cup wall portions 32 to strengthen the cup body 34. In the embodiment, the folding portions 33 for strengthening the cup body 34 are attached to two opposite cup wall portions 32 of the teacup 3. In FIG. 1, only the folding portions 33 for strengthening the cup body 34 at one surface are shown. Actually, the folding portions 33 at the opposite surface may also be disposed. Thereby, the structural strength of the teacup 3 may be improved.

The folding portions 33 may be triangular, trapezoid, or have other shapes after folded. Further, the folding portions 33 may be folded into a containing space 341 of the cup body 34 and be fastened to inner surfaces of the cup wall portions 32, or the folding portions 33 may also be folded to outside of the containing space 341 of the cup body 34 and be fastened to outer surfaces of the cup wall portions 32. In the embodiment, the folding portions 33 are triangular, and the folding portions 33 are folded to the outside and are fastened to the outer surfaces of the two opposite cup wall portions 32. However, the invention is not limited thereto. Certainly, the folding portions 33 may be fastened to the side surfaces of the four cup wall portions 32 in other folding modes.

In addition, as shown in FIG. 1, in the embodiment, the disposable tea set 1 may include a tea bag 4. However, the invention is not limited thereto. According to different needs, the user may use tea leaves. The tea bag 4 has a tea filtering packet 41 and a connecting string 42. The tea filtering packet 41 may contain tea leaves, and the tea filtering packet 41 may be made of non-woven fabric. The connecting string 42 is connected with the tea filtering packet 41 and the lid handle G of the pot lid portion 24. In other words, the tea bag 4 is directly fastened to the pot lid portion 24. The tea bag 4 may also be replaceable. That is, the tea bag 4 is not connected with the lid handle G of the pot lid portion 24.

Therefore, since the teapot 2 of the disposable tea set 1 includes the pot lid portion 24, when the user infuses the tea bag 4, the tea flavor may be retained in the teapot 2 to make the tea to be more perfumed. Thus, the user may enjoy infusing tea and obtain better tea at the same time by the disposable tea set 1.

In addition, in the embodiment, the disposable tea set 1 further include a thermochromic ink pattern disposed at an outer surface of the first sheet P1 of the teapot 2 and an outer surface of the second sheet P2 of the teacup 3. The color of the thermochromic ink pattern will change with different temperatures. Therefore, when hot water is poured into the teapot 2 or the teacup 3, the user knows a water level in the teapot 2 or the teacup 3, thereby preventing pouring too much water from overflowing to cause scald and increasing a visual effect.

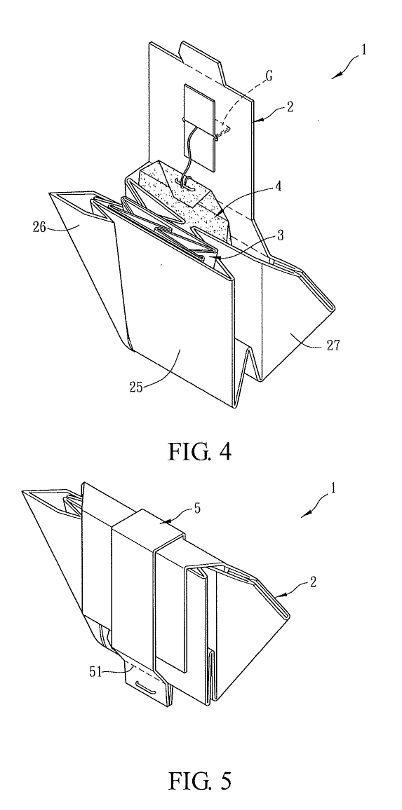

FIG. 4 is a schematic diagram showing a storage mode of the disposable tea set 1 according to one preferred embodiment of the invention. In FIG. 1 and FIG. 4, the teapot 2 may have a storage folding line 28, and the teacup 3 may have a storage folding line 35. Therefore, the teapot 2 and the teacup 3 are foldable along the storage folding lines 28, 35, respectively. The teacup 3 and the tea bag 4 may be accommodated in the teapot 2. According to different needs, the folding modes of the teapot 2 and the teacup 3 may be different. However, the invention is not limited thereto. In addition, the disposition places of the teacup 3 and the tea bag 4 in the teapot 2 are not limited.

Thereby, the teacup 3 and the tea bag 4 may be accommodated in the teapot 2. Further, the teapot 2 and the teacup 3 are foldable, such that the users conveniently take with and use the disposable tea set 1.

FIG. 5 is a schematic diagram showing a disposable tea set 1 in a storage sate according to one preferred embodiment of the invention. In FIG. 4 and FIG. 5, the disposable tea set 1 further includes a fastening tape 5. The fastening tape 5 may be folded from a sheet of paper. After the teacup 3 and the tea bag 4 are accommodated in the teapot 2, the fastening tape 5 may surround the outside of the teapot 2. Therefore, the volume of the disposable tea set 1 is further reduced by the fastening tape 5. When the user is to use the disposable tea set 1, he or she just needs to tear or cut the fastening tape 5 along a cutting line 51, thereby taking out of the disposable tea set 1.

To sum up, in the embodiment of the invention, the teapot and the teacup included by the disposable tea set are folded from a single sheet, such as paper, respectively. Thereby, the teapot and the teacup are light, and the teacup can be accommodated in the teapot. Further, the teapot and the teacup are foldable, such that the disposable tea set can be conveniently taken and used. In addition, the teapot in the invention has the pot lid portion. When the user infuses the tea bag, the tea flavor can be retained in the teapot to allow the tea to be more perfumed.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A teapot folded from a sheet, the sheet comprising:
a pot bottom portion;
a plurality of pot wall portions, the pot wall portions surrounding and connected with the pot bottom portion, the pot wall portions and the pot bottom portion are seamless;
a plurality of folding portions for connecting the pot wall portions which are adjacent to each other respectively, and folded to make the pot wall portions to form a pot body, one of the folding portions extending to outside of the pot body to form a spout; and
a pot lid portion connected with one of the pot wall portions.

2. The teapot according to claim 1, wherein the folding portions and the pot wall portions are seamless.

3. The teapot according to claim 1, wherein one of the folding portions extends to outside of the pot body to form a handle.

4. The teapot according to claim 1, wherein one of the folding portions extends to be attached to one of the pot wall portions.

5. The teapot according to claim 1, wherein part of the folding portion extending to outside of the pot body to form the spout is attached to one of the pot wall portions.

6. The teapot according to claim 1, wherein the teapot has a first folding line for storage, and the teapot is foldable along the first folding line.

7. The teapot according to claim 1, further comprising:
a thermochromic ink pattern disposed at an outer surface of the sheet.

8. A disposable tea set comprising:
a teapot folded from a first sheet, the first sheet including:
a pot bottom portion;
a plurality of pot wall portions, the pot wall portions surrounding and connected with the pot bottom portion, the pot wall portions and the pot bottom portion are seamless;
a plurality of folding portions for connecting the pot wall portions which are adjacent to each other respectively, and folded to make the pot wall portions to form a pot body, one of the folding portions extending to outside of the pot body to form a spout; and
a pot lid portion connected with one of the pot wall portions; and
a teacup folded from a second sheet and accommodated in the teapot.

9. The disposable tea set according to claim 8, wherein the folding portions and the pot wall portions are seamless.

10. The disposable tea set according to claim 8, wherein one of the folding portions extends to outside of the pot body to fonn a handle.

11. The disposable tea set according to claim 8, wherein one of the folding portions extends to be attached to one of the pot wall portions.

12. The disposable tea set according to claim 8, wherein part of the folding portion extending to outside of the pot body to form the spout is attached to one of the pot wall portions.

13. The disposable tea set according to claim 8, wherein the teapot has a folding line for storage, and the teapot is foldable along the folding line.

14. The disposable tea set according to claim 8, further comprising:
a fastening tape surrounding the teapot.

15. The disposable tea set according to claim 8, further comprising:
a thermochromic ink pattern disposed at an outer surface of the first sheet or an outer surface of the second sheet.

16. The disposable tea set according to claim 8, further comprising:
a tea bag accommodated in the teapot.

17. The disposable tea set according to claim 16, wherein the tea bag is connected with the pot lid portion.

18. The disposable tea set according to claim 8, wherein the teacup has a second folding line for storage, and the teacup is foldable along the second folding line.
